(19) United States
(12) Patent Application Publication
(10) Pub. No.: US 2009/0135606 A1
(43) Pub. Date: May 28, 2009

(54) MULTI-REFLECTOR MECHANISM FOR A LED LIGHT SOURCE

(75) Inventor: TONY CHUNLUNG YOUNG, Hong Kong (HK)

Correspondence Address: ERIC CHAN, 42 PIN OAKS DRIVE, PHOENIXVILLE, PA, 19460, US

(73) Assignee: CALTRACO INTERNATIONAL LIMITED, Hong Kong (HK)

(21) Appl. No.: 11/946,048

(22) Filed: Nov. 28, 2007

(51) Int. Cl. F21V 7/04; F21V 7/06; F21V 23/04

(52) U.S. Cl. 362/310; 362/346; 362/394

(57) ABSTRACT

A multi-reflector mechanism for a LED light source which comprises a LED light source, an outer parabolic reflector, an inner parabolic reflector and a sliding switch, wherein the inner reflector is disposed within the outer reflector with the focuses of both reflectors being different points on a common axis, and the focus of the outer reflector being the highest one nearest to the plane of the opening of the outer reflector; and the LED light source is disposed within the inner reflector and protrudes out from the vertex of the inner reflector and is coaxially and adjustably disposed at or near the focus of the inner reflector or of the outer reflector, and the light emitting angle of the LED light source is larger than the angle formed by the two points on the edge of the opening forming the diameter thereof and the focus of the inner reflector. The present invention can emit a bright, sharp and wide spot of light at a shorter distance and, as an alternative by means of a sliding switch, a bright, sharp and small spot of light at a farther distance.

### BACKGROUND OF THE INVENTION

The present invention relates to a LED light source for use in lighting equipment powered by dry cells such as a flashlight, lantern, bicycle light or an emergency light or powered by A/C power such as a wall light and more particularly pertains to a multi-reflector mechanism for such a LED light source.

An existing LED light source typically has a parabolic reflector to reflect the light rays from the LED. To achieve the best reflection results as shown in FIG. 1, the parabola formula of the reflector's arc is Y²=4Ax, in which A is the focus, that is, a point toward which the light rays are made to converge. Due to the geometric properties of the paraboloid shape, the angle of incidence to the inner surface of the reflector equals the angle of reflection, and any incoming ray that is parallel to the axis of the reflector will be reflected to a central point forming the focus. Similarly, light rays radiating from the focus to the reflector can be transmitted outward in a beam that is parallel to the axis of the reflector. Therefore, the maximum light emitting center of the LED is usually disposed at the focus. However, parabolic reflectors do suffer from an aberration called coma. When the light source is off-center or off-axis, the different parts of the reflector do not reflect the light rays to the same point. This results in a point of light that is not in the center of the field looking wedge-shaped. The further off-axis, the worse this effect is. In real life, it may be too costly to produce each and every parabolic reflector with the said parabola formula and to dispose each and every maximum light emitting center of the LED at the focus of the parabolic reflector with 100% accuracy. This is particularly the case if the lighting device is not of high value such as a flashlight.

For example, in a common LED flashlight, it has one LED or an array of LEDs as the light source with an associated parabolic reflector to redirect the light rays from the LED creating a steady beam of light which is the light emitting from the flashlight. In general, the size of the parabolic reflector is in direct proportion as to the size of the LED as used. It is common for a flashlight to use one 1 W white LED having a square cross-section of 0.6×0.6 to 1.5×1.5 mm diameter with a light emitting angle of 100 to 160 degrees powered by 1.5V or above 4 D alkaline cells as the light source. Such a typical LED flashlight usually has a parabolic reflector with a small opening at the center just fit for holding the LED and an opposite wide opening of about 80 to 90 mm diameter, and the distance between the small opening and the wide opening ranges from about 40 to 55 mm. The shape of the parabolic reflector is shown in FIG. 1. The parabola formula of the reflector's arc is Y²=4Ax. The parabolic reflector can produce a tight light beam forming a small spot of light at an illumination range of 3 meters (approx. 10 feet) or above. However, with the parabolic reflector and the maximum light emitting center of the LED being disposed at the focus, only about 10% of the intensity of the light source is reflected when a spot of light is formed within an illumination range of 1 meter (approx. 3 feet). Therefore, when the flashlight is used for a shorter distance of about 1 to 3 meters (approx. 1 to 10 feet), the spot of light becomes too small with grey areas forming at and near the center of the spot and it is far from being an ideal for a short distance or an indoor application. There are some flashlights with a digitally controlled two-stage switch that allows a user to choose either a low-output beam for close-up or indoor work or a high-output beam for outdoor work. These are of high manufacturing costs as a magnifier lens has to be incorporated in order to enable the dual output mode. And, such flashlights are thus not economically available to the majority of the buying public. Further, such flashlights are generally heavier and more bulky and are therefore not convenient for use.

There are different dual reflector lighting mechanisms in the known art. These mechanisms are mainly for gaseous discharge lamps and some for fluorescent lamps. In essence, as shown in FIG. 2, a typical dual reflector assembly includes an outer reflector of a parabolic shape to reflect a portion of light from the lamp; an inner reflector also of a parabolic shape adapted to fit within the outer reflector to reflect a substantial amount of light from the lamp; and an adjusting assembly for adjusting the outer reflector and the inner reflector relative to each other to obtain the desired focusing of light beams and the desired light spread. However, there is no prior art disclosing such a mechanism for a LED light source.

Gaseous discharge and fluorescent lamps in the prior art are powered by relatively high power A/C power supply. The applications are all fixed or non-portable and call for high mounting above the lighting area. Incandescent and fluorescent light sources provide a larger area source, and in contrast LEDs provide a small area source. LEDs typically cast light in one direction at a narrow angle compared to an incandescent or fluorescent lamp of the same lumen level. Further, LEDs can be designed to focus light, while incandescent and fluorescent sources often require an external reflector to collect light and direct it in a usable manner. In addition, gaseous discharge and fluorescent lamps generate significant amounts of heat in comparison with LEDs. And, unlike gaseous discharge lamps and fluorescent lamps, LEDs do not require a ballast. Therefore, in any dual reflector assembly for a gaseous discharge or fluorescent lamp the focal point of the inner reflector must block the focal point of the outer reflector so as to prevent a focused spot or hot spot from forming by the outer reflector. Otherwise, the light bulb and the ballast will burn out easily because of over-heating. The adjusting assembly of the prior art also requires tools to do the focusing adjustment and it is not convenient for use as the light bulb is connected to the ballast and is fragile and has to be a non-movable unit. To a person having skill in the related area of technology, a dual reflector mechanism for a LED light source appears to be not practical as LEDs operate differently from gaseous discharge and fluorescent lamps and the dual reflector mechanism may not work on a LED light source, and it appears to be not cost-effective as well because it should take time and resources to devise an optimal shape for the inner reflector and the benefits generated may not justify the additional cost of producing and incorporating the inner reflector.

### BRIEF SUMMARY OF THE INVENTION

In view of the aforesaid disadvantages now present in the prior art, the object of the present invention is to provide a new multi-reflector mechanism for a LED light source which can emit a bright, sharp and wide spot of light at a shorter distance such as within an illumination range of about 1 to 3 meters (approx. 1 to 10 feet) and, as an alternative by means of a sliding switch, a bright, sharp and small spot of light at a farther distance such as within an illumination range of 3 meters (approx. 10 feet) or above.

It is another object of the present invention to provide a new multi-reflector mechanism for a LED light source which is susceptible of a low cost of manufacture with regard to both materials and labor, and which accordingly is then susceptible of a low price of sale to the buying public.

It is a further object of the present invention to provide a new multi-reflector mechanism for a LED light source which is light in weight and compact in size and is simple and convenient to use.

To attain this, the present invention generally comprises a LED light source, an outer parabolic reflector, an inner parabolic reflector and a sliding switch, wherein the formulae of the arcs of the outer reflector and the inner reflector are each Y²=4Ax, in which A is the focus of the respective reflector, and the inner reflector is disposed within the outer reflector with the openings of both reflectors facing the same direction, the distance between the opening and the vertex of the outer reflector being longer than that of the inner reflector, the focuses of both reflectors being different points on a common axis, and the focus of the outer reflector being the highest one nearest to the plane of the opening of the outer reflector; and the LED light source is disposed within the inner reflector and protrudes out from the vertex of the inner reflector and is coaxially and adjustably disposed at or near the focus of the inner reflector or of the outer reflector, and the light emitting angle of the LED light source is larger than the angle formed by the two points on the edge of the opening forming the diameter thereof and the focus of the inner reflector; and the sliding switch is connected to the LED light source for mechanically moving the LED light source coaxially relative to the inner reflector and the outer reflector to the focus of the inner reflector or to the focus of the outer reflector.

The present invention further comprises an additional inner parabolic reflector, wherein the formula of the arc of the additional inner reflector is Y²=4Ax, in which A is the focus of the additional inner reflector, and the additional inner reflector is smaller in size than the inner reflector and is disposed within the inner reflector with the openings of both inner reflectors facing the same direction, the distance between the opening and the vertex of the additional inner reflector being shorter than that of the inner reflector, the focuses of both inner reflectors being different points on a common axis; and the LED light source is disposed within the additional inner reflector and protrudes out from the vertex of the additional inner reflector and is coaxially and adjustably disposed at or near the focus of the additional inner reflector or of the outer reflector, and the light emitting angle of the LED light source is larger than the angle formed by the two points on the edge of the opening forming the diameter thereof and the focus of the additional inner reflector; and the sliding switch is connected to the LED light source for mechanically moving the LED light source coaxially relative to the additional inner reflector and the outer reflector to the focus of the additional inner reflector or to the focus of the outer reflector.

The outer reflector has an orifice at its vertex through which a corresponding connecting part of the inner reflector passes, thereby fixing the inner reflector within the outer reflector. The orifice may be in the form of a short section of a pipe and the inner reflector may then have a corresponding connecting part for engaging with the pipe. The size of the outer reflector is in direct proportion as to the size of the LED light source as used.

Where there is no additional inner reflector, the inner reflector has an orifice at its vertex through which the LED light source is coaxially disposed and protrudes out.

Where there is any additional inner reflector, the inner reflector has an orifice at its vertex through which a corresponding connecting part of the additional inner reflector passes, thereby fixing the additional inner reflector within the inner reflector. The orifice may be in the form of a short section of a pipe and the additional inner reflector may then have a corresponding connecting part for engaging with the pipe.

The additional inner reflectors each has an orifice at its vertex through which a corresponding connecting part of the next smaller additional inner reflector passes, thereby fixing the next smaller additional inner reflector within the additional inner reflector. The orifice may be in the form of a short section of a pipe and the next smaller additional inner reflector may then have a corresponding connecting part for engaging with the pipe.

The additional innermost reflector has an orifice at its vertex through which the LED light source is coaxially disposed and protrudes out.

The LED light source can be one or more LED light bulbs which can be used as a lighting source. It is preferable to use a single white LED light bulb having a square cross-section of 0.6×0.6 to 1.5×1.5 mm diameter with a light emitting angle from 90 to 180 degrees which operates with 0.5 W or above of electrical power as it is commonly used in a typical flashlight or lantern.

The sliding switch is manually operated and has a sliding holder and the LED light source is disposed at one end of the sliding holder. By pushing the sliding switch, the sliding holder can slide forward and can therefore move the LED light source from the focus of the inner reflector or the additional innermost reflector to the focus of the outer reflector.

The reflective surfaces of the outer reflector, the inner reflector and the additional inner reflector(s) may be made of metals such as aluminum polished with mirror finishes or plastics painted with reflective materials commonly used in the field.

To produce a bright, sharp and small spot of light at an illumination range of 3 meters (approx. 10 feet) or above by the present invention, the user can push the sliding switch forward to move the LED light source to the focus of the outer reflector, so that most of the light rays emitted by the LED light source will not be captured by the inner reflector and the additional inner reflector(s) if any but will be captured by the outer reflector.

To produce a bright, sharp and wide spot of light at an illumination range of about 1 to 3 meters (approx. 1 to 10 feet) by the present invention, the user can push the sliding switch downward to move the LED light source to the focus of the inner reflector or the additional innermost reflector(s) if any, so that most of the light rays emitted by the LED light source will be captured by the inner reflector and the additional innermost reflector(s) and not by the outer reflector. The spot of light is without grey areas forming at and near the center of the spot and it is ideal for a short distance or an indoor application.

In comparison with the prior art, the present invention has the following advantages and effects:

Firstly, the present invention can produce a bright, sharp and wide spot of light at a shorter distance such as within an illumination range of about 1 to 3 meters (approx. 1 to 10 feet) and can therefore overcome the defects of the existing lighting equipment such as a flashlight and lantern which provides only a small spot of light with grey areas forming at and near the center of the spot and it is far from being an ideal for a short distance or an indoor application.

Secondly, since the present invention only requires one or more additional reflectors and a simple sliding switch and no magnifier lens is required, the cost of manufacture is lower with regard to both materials and labor.

Thirdly, by means of a sliding switch, a bright, sharp and small spot of light at a farther distance such as within an illumination range of 3 meters (approx. 10 feet) or above can be provided. The present invention can therefore provide two modes of spread of light with one configuration, it is more simple and convenient to use. Further, as the present invention does not have many parts, its construction is light in weight and compact in size.

Further objects, features, and advantages of the invention will become more apparent from the following description and the appended claims with reference to the accompanying drawings, all of which form a part of this specification.

### BRIEF DESCRIPTION OF THE DRAWINGS

FIG. 1 shows the parabolic reflector and the light rays reflected of a typical LED flashlight of the known art.

FIG. 2 shows the construction of a typical dual reflector assembly of a gaseous discharge lamp of the known art.

FIG. 3 shows the first embodiment of the present invention where the LED light source is at the focus of the inner reflector.

FIG. 4 shows the light rays reflected of the first embodiment where the LED light source is at the focus of the inner reflector.

FIG. 5 shows the first embodiment where the LED light source is at the focus of the outer reflector.

FIG. 6 shows the light rays reflected of the first embodiment where the LED light source is at the focus of the outer reflector.

FIG. 7 shows the second embodiment of the present invention where the LED light source is at the focus of the additional inner reflector.

FIG. 8 shows the light rays reflected of the second embodiment where the LED light source is at the focus of the additional inner reflector.

FIG. 9 shows the second embodiment where the LED light source is at the focus of the outer reflector.

FIG. 10 shows the light rays reflected of the second embodiment where the LED light source is at the focus of the outer reflector.

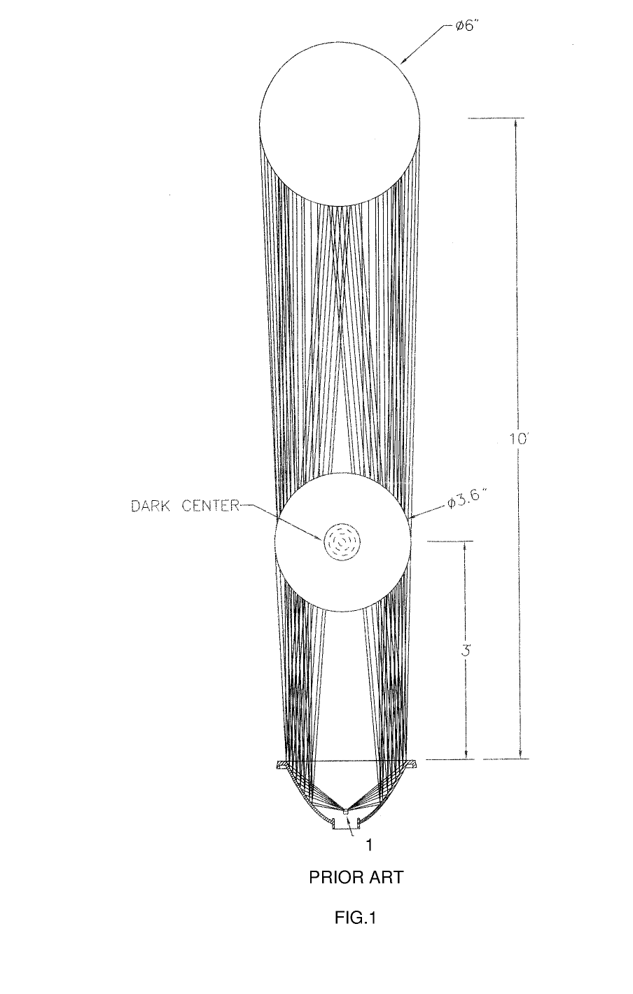

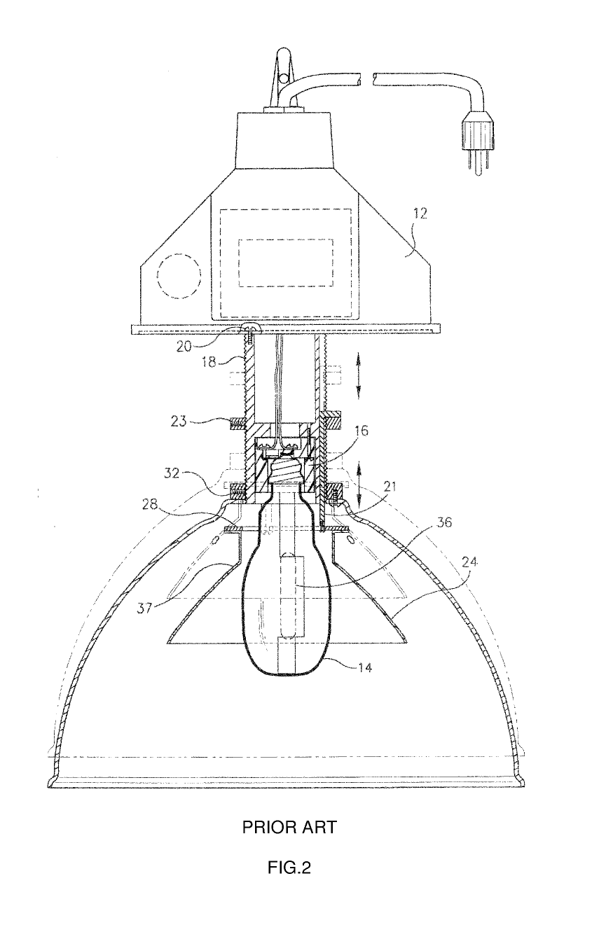

### DETAILED DESCRIPTION OF THE INVENTION

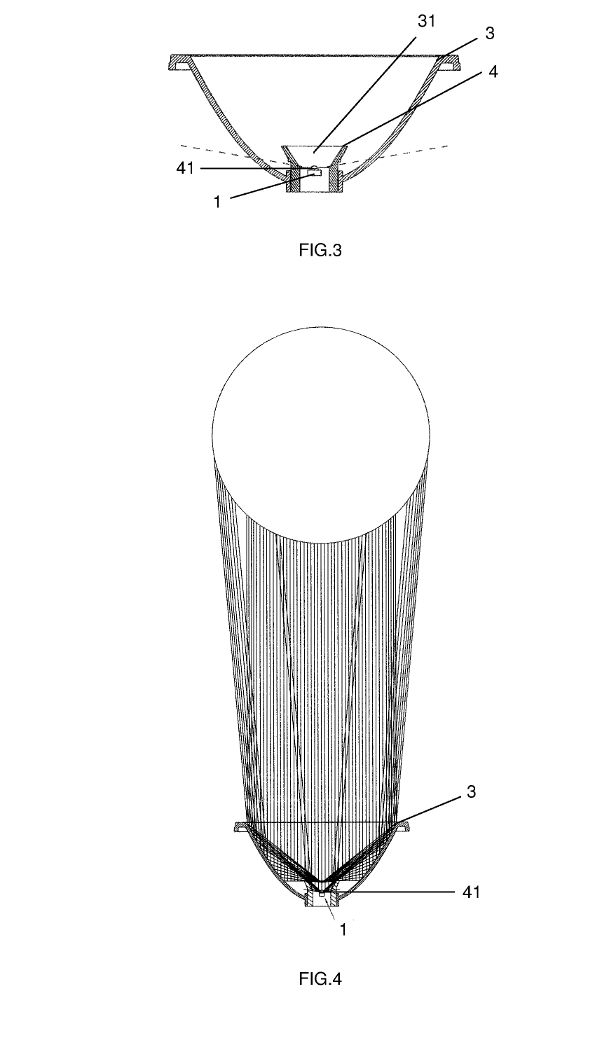

The present invention is further described in detail with the following embodiments and the accompanying drawings. FIGS. 3 to 6 illustrate the first embodiment of the present invention, which is used in a common flashlight.

As shown in FIGS. 3 and 5, this embodiment comprises a LED light source 1, an outer parabolic reflector 3, an inner parabolic reflector 4 and a sliding switch 2. The formulae of the arcs of the outer reflector 3 and the inner reflector 4 are each Y²=4Ax, in which A is the focus of the respective reflector, and the inner reflector 4 is disposed within the outer reflector 3 with the openings of both reflectors facing the same direction, the distance between the opening and the vertex of the outer reflector 3 being longer than that of the inner reflector 4, the focuses 31, 41 of both reflectors being different points on a common axis, and the focus 31 of the outer reflector 3 being the highest one nearest to the plane of the opening of the outer reflector 3; and the LED light source 1 is disposed within the inner reflector 4 and protrudes out from the vertex of the inner reflector 4 and is coaxially and adjustably disposed at or near the focus 41, 31 of the inner reflector 4 or of the outer reflector 3, and the light emitting angle α1 of the LED light source 1 is larger than the angle α2 formed by the two points on the edge of the opening forming the diameter thereof and the focus 41 of the inner reflector 4; and the sliding switch is connected to the LED light source 1 for mechanically moving the LED light source 1 coaxially relative to the inner reflector 4 and the outer reflector 3 to the focus 41 of the inner reflector 4 or to the focus 31 of the outer reflector 3. The outer reflector 3 has an orifice at its vertex through which a corresponding connecting part of the inner reflector 4 passes, thereby fixing the inner reflector 4 within the outer reflector 3. The orifice is in the form of a short section of a pipe and the inner reflector 4 has a corresponding connecting part for engaging with the pipe. The inner reflector 4 has an orifice at its vertex through which the LED light source 1 is coaxially disposed and protrudes out.

The sliding switch is manually operated and has a sliding holder and the LED light source 1 is disposed at one end of the sliding holder. By pushing the sliding switch, the sliding holder can slide forward and can therefore move the LED light source 1 from the focus 41 of the inner reflector 4 to the focus 31 of the outer reflector 3.

In the first embodiment, the LED light source 1 is one single 1 W white LED light bulb having a square cross-section of 0.6×0.6 to 1.5×1.5 mm diameter with a light emitting angle of 100 to 180 degrees which is powered by 1.5V or above 4 D alkaline cells. In other embodiments, the LED light source can be two or more LED light bulbs.

In this embodiment, the opening of the outer reflector 3 is of about 80 to 90 mm diameter and the distance between the opening and the vertex of the outer reflector 3 ranges from about 40 to 55 mm. In other embodiments, the size of the outer reflector is in direct proportion as to the size of the LED light source as used.

In this embodiment, the reflective surfaces of the outer reflector 3 and the inner reflector 4 are made of aluminum polished with mirror finishes. In other embodiments, they can be made of other metals polished with mirror finishes or plastics painted with reflective materials commonly used in the field.

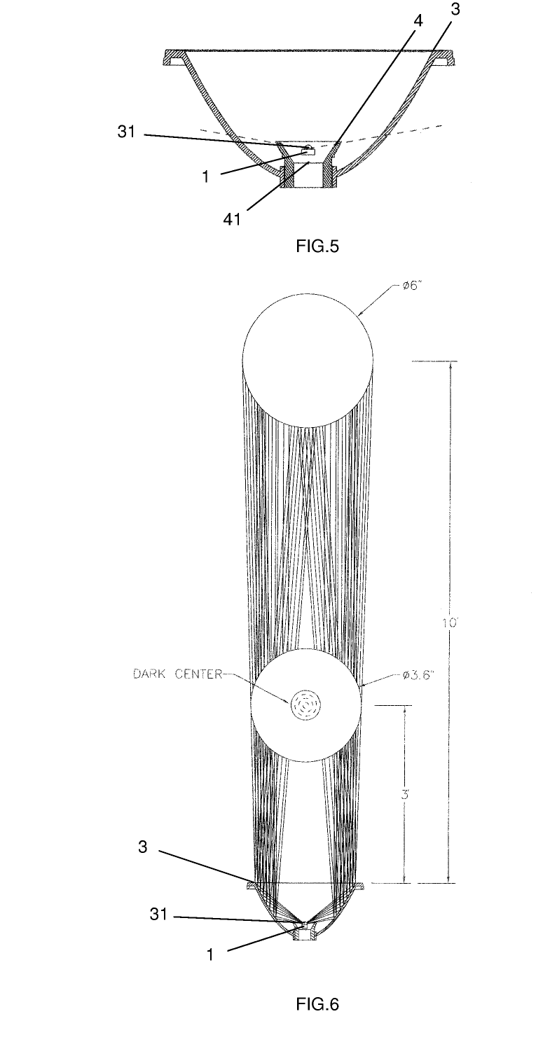

As shown in FIG. 6, the first embodiment can produce a bright, sharp and small spot of light at an illumination range of 3 meters (approx. 10 feet) or above. The user can push the sliding switch forward to move the LED light source 1 to the focus 31 of the outer reflector 3, so that most of the light rays emitted by the LED light source 1 will not be captured by the inner reflector 4 but will be captured by the outer reflector 3.

As shown in FIG. 4, the first embodiment can alternatively produce a bright, sharp and wide spot of light at an illumination range of about 1 to 3 meters (approx. 1 to 10 feet). The user can push the sliding switch downward to move the LED light source 1 to the focus 41 of the inner reflector 4, so that most of the light rays emitted by the LED light source 1 will be captured by the inner reflector 4 and not by the outer reflector 3. The spot of light is without grey areas forming at and near the center of the spot and it is ideal for a short distance or an indoor application. The first embodiment can therefore overcome the defects of the existing lighting equipment which provides only a small spot of light with grey areas forming at and near the center of the spot.

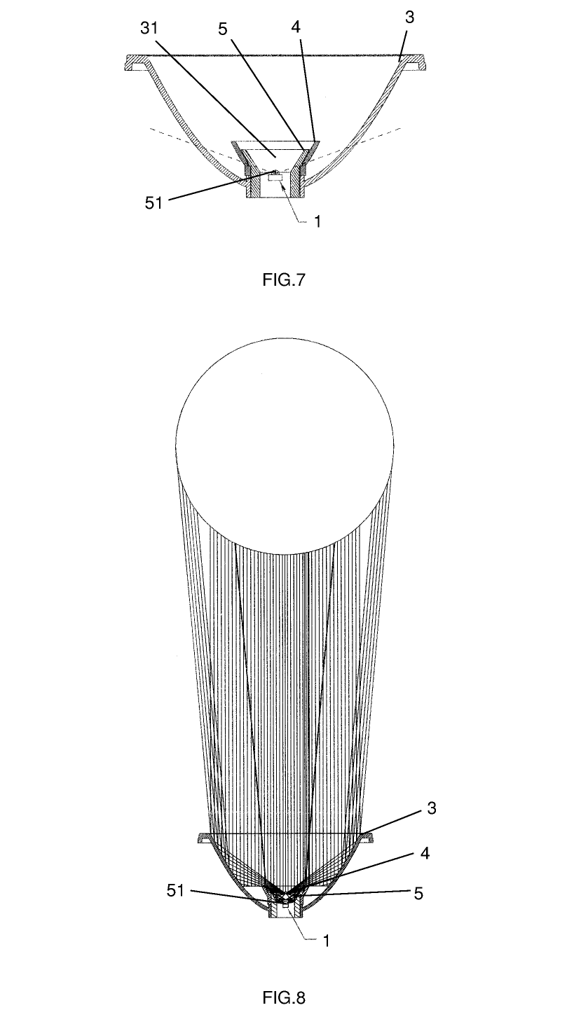

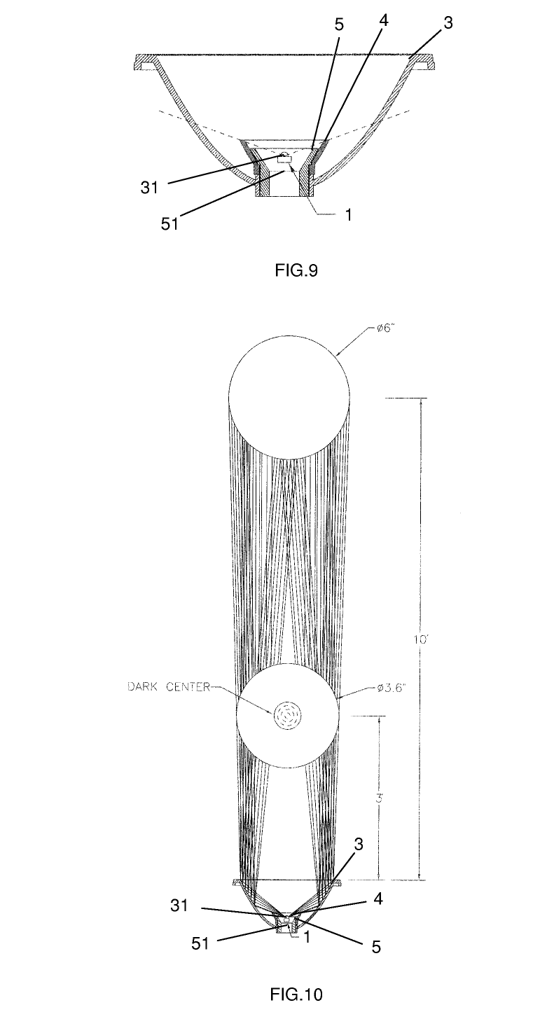

FIGS. 7 to 10 illustrate the second embodiment of the present invention, which is also used in a common flashlight. As shown in 7 and 9, the configuration is substantially identical to the first embodiment save that the second embodiment further has an additional inner parabolic reflector 5. The formula of the arc of the additional inner reflector 5 is Y²=4Ax, in which A is the focus 51 of the additional inner reflector 5, and the additional inner reflector 5 is smaller in size than the inner reflector 4 and is disposed within the inner reflector 4 with the openings of both inner reflectors facing the same direction, the distance between the opening and the vertex of the additional inner reflector 5 being shorter than that of the inner reflector 4, the focuses 41, 51 of both inner reflectors being different points on a common axis; and the LED light source 1 is disposed within the additional inner reflector 5 and protrudes out from the vertex of the additional inner reflector 5 and is coaxially and adjustably disposed at or near the focus 51, 31 of the additional inner reflector 5 or of the outer reflector 3, and the light emitting angle α1 of the LED light source 1 is larger than the angle α3 formed by the two points on the edge of the opening forming the diameter thereof and the focus 51 of the additional inner reflector 5; and the sliding switch is connected to the LED light source 1 for mechanically moving the LED light source 1 coaxially relative to the additional inner reflector 5 and the outer reflector 3 to the focus 51 of the additional inner reflector 5 or to the focus 31 of the outer reflector 3.

The inner reflector 4 has an orifice at its vertex through which a corresponding connecting part of the additional inner reflector 5 passes, thereby fixing the additional inner reflector 5 within the inner reflector 4. The orifice is in the form of a short section of a pipe and the additional inner reflector 5 has a corresponding connecting part for engaging with the pipe.

As shown in FIG. 10, the second embodiment can produce a bright, sharp and small spot of light at an illumination range of 3 meters (approx. 10 feet) or above. The user can push the sliding switch forward to move the LED light source 1 to the focus 31 of the outer reflector 3, so that most of the light rays emitted by the LED light source 1 will not be captured by the inner reflector 4 and the additional inner reflector 5 but will be captured by the outer reflector 3.

As shown in FIG. 8, the second embodiment can alternatively produce a bright, sharp and wide spot of light at an illumination range of about 1 to 3 meters (approx. 1 to 10 feet). The user can push the sliding switch downward to move the LED light source 1 to the focus 51 of the additional inner reflector 5, so that most of the light rays emitted by the LED light source 1 will be captured by the additional inner reflector 5 and the inner reflector 4 and not by the outer reflector 3. The spot of light is without grey areas forming at and near the center of the spot and it is ideal for a short distance or an indoor application. The second embodiment can therefore overcome the defects of the existing lighting equipment which provides only a small spot of light with grey areas forming at and near the center of the spot.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A multi-reflector mechanism for a LED light source which comprises a LED light source, an outer parabolic reflector, an inner parabolic reflector and a sliding switch, wherein the formulae of the arcs of the outer reflector and the inner reflector are each Y²=4Ax, in which A is the focus of the respective reflector, and the inner reflector is disposed within the outer reflector with the openings of both reflectors facing the same direction, the distance between the opening and the vertex of the outer reflector being longer than that of the inner reflector, the focuses of both reflectors being different points on a common axis, and the focus of the outer reflector being the highest one nearest to the plane of the opening of the outer reflector; and the LED light source is disposed within the inner reflector and protrudes out from the vertex of the inner reflector and is coaxially and adjustably disposed at or near the focus of the inner reflector or of the outer reflector, and the light emitting angle of the LED light source is larger than the angle formed by the two points on the edge of the opening forming the diameter thereof and the focus of the inner reflector; and the sliding switch is connected to the LED light source for mechanically moving the LED light source coaxially relative to the inner reflector and the outer reflector to the focus of the inner reflector or to the focus of the outer reflector.

2. The multi-reflector mechanism for a LED light source as in claim 1, wherein it further comprises an additional inner parabolic reflector, wherein the formula of the arc of the additional inner reflector is Y²=4Ax, in which A is the focus of the additional inner reflector, and the additional inner reflector is smaller in size than the inner reflector and is disposed within the inner reflector with the openings of both inner reflectors facing the same direction, the distance between the opening and the vertex of the additional inner reflector being shorter than that of the inner reflector, the focuses of both inner reflectors being different points on a common axis; and the LED light source is disposed within the additional inner reflector and protrudes out from the vertex of the additional inner reflector and is coaxially and adjustably disposed at or near the focus of the additional inner reflector or of the outer reflector, and the light emitting angle of the LED light source is larger than the angle formed by the two points on the edge of the opening forming the diameter thereof and the focus of the additional inner reflector; and the sliding switch is connected to the LED light source for mechanically moving the LED light source coaxially relative to the additional inner reflector and the outer reflector to the focus of the additional inner reflector or to the focus of the outer reflector.

3. The multi-reflector mechanism for a LED light source as in claim 1, wherein it further comprises two or more additional inner parabolic reflectors, wherein the formulae of the arcs of the additional inner reflectors are each Y²=4Ax, in which A is the focus of the respective reflector, and the additional inner reflectors are of decreasing sizes disposed one within another with the opening of each facing the same direction as the inner reflector, the distances between the openings and the vertexes of the additional inner reflectors being of decreasing lengths in proportional to their sizes, the focuses of the additional inner reflectors being different points on a common axis; and the LED light source is disposed within the additional innermost reflector and protrudes out from the vertex of the additional innermost reflector and is coaxially and adjustably disposed at or near the focus of the additional innermost reflector or of the outer reflector, and the light emitting angle of the LED light source is larger than the angle formed by the two points on the edge of the opening forming the diameter thereof and the focus of the additional innermost reflector; and the sliding switch is connected to the LED light source for mechanically moving the LED light source coaxially relative to the additional inner reflectors and the outer reflector to the focus of the additional innermost reflector or to the focus of the outer reflector.

4. The multi-reflector mechanism for a LED light source as in claim 3, wherein the number of the additional inner reflectors required depends on the size of the LED light source.

5. The multi-reflector mechanism for a LED light source as in claim 1, wherein the size of the outer reflector is in direct proportion as to the size of the LED light source.

6. The multi-reflector mechanism for a LED light source as in claim 1, wherein the outer reflector has an orifice at its vertex through which a corresponding connecting part of the inner reflector passes, thereby fixing the inner reflector within the outer reflector.

7. The multi-reflector mechanism for a LED light source as in claim 6, wherein the orifice is in the form of a short section of a pipe and the inner reflector has a corresponding connecting part for engaging with the pipe.

8. The multi-reflector mechanism for a LED light source as in claim 1, wherein the inner reflector has an orifice at its vertex through which the LED light source is coaxially disposed and protrudes out.

9. The multi-reflector mechanism for a LED light source as in claim 2, wherein the inner reflector has an orifice at its vertex through which a corresponding connecting part of the additional inner reflector passes, thereby fixing the additional inner reflector within the inner reflector; and the additional inner reflector has an orifice at its vertex through which the LED light source is coaxially disposed and protrudes out.

10. The multi-reflector mechanism for a LED light source as in claim 9, wherein the orifice of the inner reflector is in the form of a short section of a pipe and the additional inner reflector has a corresponding connecting part for engaging with the pipe.

11. The multi-reflector mechanism for a LED light source as in claim 3, wherein the additional inner reflectors each has an orifice at its vertex through which a corresponding connecting part of the next smaller additional inner reflector passes, thereby fixing the next smaller additional inner reflector within the additional inner reflector; and the additional innermost reflector has an orifice at its vertex through which the LED light source is coaxially disposed and protrudes out.

12. The multi-reflector mechanism for a LED light source as in claim 11, wherein the orifice of each of the additional inner reflectors is in the form of a short section of a pipe and the next smaller additional inner reflector has a corresponding connecting part for engaging with the pipe.

13. The multi-reflector mechanism for a LED light source as in claim 1, wherein the LED light source is one or more LED light bulbs.

14. The multi-reflector mechanism for a LED light source as in claim 1, wherein the sliding switch is manually operated and has a sliding holder and the LED light source is disposed at one end of the sliding holder.
